(19) United States
(12) Patent Application Publication
(10) Pub. No.: US 2009/0254850 A1
(43) Pub. Date: Oct. 8, 2009

(54) System providing progress indicator for monitor firmware loading process

(75) Inventor: Timothy Almeida, Corona, CA (US)

Correspondence Address: GATEWAY, INC.;ATTN: Patent Attorney, 610 GATEWAY DRIVE, MAIL DROP Y-04, N. SIOUX CITY, SD, 57049, US

(73) Assignee: Gateway Inc.

(21) Appl. No.: 12/080,295

(22) Filed: Apr. 2, 2008

(51) Int. Cl. G06F 3/048

(52) U.S. Cl. 715/772

(57) ABSTRACT

A method of providing an indication to a user of a status of an updating process of a video display monitor is disclosed. The method comprising receiving a set of instructions by the video display monitor, loading the set of instructions into a memory of the video display monitor, detecting a status of the loading of the set of instructions into the memory of the video display monitor, generating an indication of the status of the loading of the set of instructions into the memory of the video display monitor, and displaying the indication of the status of the loading of the set of instructions by the video display monitor.

### BACKGROUND OF THE INVENTION

1. Field of the Invention

The present invention relates to video displays, and more particularly pertains to a new method and apparatus for informing a user of the status of the loading of firmware onto the memory of the video display to discourage interruption of the loading process premature to the completion of the loading process.

2. Description of the Prior Art

Traditionally, computer display monitors have typically been a relatively passive or “dumb” component of a computer system, but the inclusion of processing and memory capabilities in display monitors has permitted the monitors to gain a greater degree of autonomy of operation from the central processing unit, as well as provided the monitor with the capability to include firmware, including the ability to update the firmware. With the ubiquity of Internet access by computer systems, firmware updates may be easily downloaded to the personal computer from a website of the seller or producer of the display monitor and then loaded into the memory of the display monitor.

The ability to update the firmware resident in the memory of the monitor has the potential benefit of providing the user with additional features and functionality after the display monitor has been purchased from the supplier, as well as providing the supplier with the opportunity to fix any possible “bugs” in the operation of the display monitor without requiring the monitor to be returned to the supplier's repair facilities for the necessary fix.

Once the firmware update file has been downloaded to the computer (either from a website on a network such as the Internet or from media such as a CD), the set of instructions of the firmware may be transferred to the memory of the display monitor via the video adapter card and the video connection cable. As the updating process (loading and storing) the set of instructions can be time consuming, and in some cases the user of the computer may become impatient waiting for the loading process to be completed, and may inadvertently interrupt the loading process by shutting off the computer, shutting of the monitor, or taking some other action that is incompatible with the continuation of the loading process in progress. When the loading process is interrupted, only a partial or otherwise incomplete set of instructions may be present in the memory, which typically affects the operation of the video display monitor and may make it inoperable as a video display for a connected computer.

Clearly, when the display monitor is no longer operational, the user will contact technical support for the manufacturer or supplier of the monitor for help in remedying the inoperable condition of the monitor, and thus may require the time of technical support personnel to diagnose the problem and cause the expense of returns of the monitor for repair or replacement.

It is therefore believed that there exists in the art a need for a system that informs the user of a display monitor as to the status of the updating of the firmware of the display monitor.

### SUMMARY OF THE INVENTION

The present invention provides a new system providing a progress indicator for a monitor firmware loading process to discourage interruption of the loading process premature to the completion of the loading process.

In one aspect of the disclosure, a method of providing an indication to a user of a status of an updating process of a video display monitor. The method comprises receiving a set of instructions by the video display monitor, loading the set of instructions into a memory of the video display monitor, detecting a status of the loading of the set of instructions into the memory of the video display monitor, generating an indication of the status of the loading of the set of instructions into the memory of the video display monitor, and displaying the indication of the status of the loading of the set of instructions by the video display monitor.

In another aspect of the disclosure, a system for providing an indication to a user of a status of an updating process of a video display monitor. The system may comprise a video display monitor including a display screen, a memory configured to store firmware instructions, a processor for executing the firmware instructions, and a first set of instructions stored on the memory. The first set of instructions is configured to cause the processor to receive a second set of instructions, load the second set of instructions into the memory, detect a status of the loading of the second set of instructions into the memory, generate an indication of the status of the loading of the second set of instructions into the memory, and display the indication of the status of the loading of the second set of instructions.

This is a general outline of the more important aspects and features of the invention, and the detailed description of this application that follows discloses additional features of the invention which form the subject matter of the claims appended hereto.

Further features and advantages of the invention which characterize the invention are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a schematic front view of a monitor showing an illustrative indication of progress of an updating process of the monitor.

FIG. 2 is a schematic diagrammatic view of elements of a system suitable for implementation of the system of the disclosure.

FIG. 3 is a schematic flow chart of a process of the present disclosure.

### DESCRIPTION OF PREFERRED EMBODIMENTS

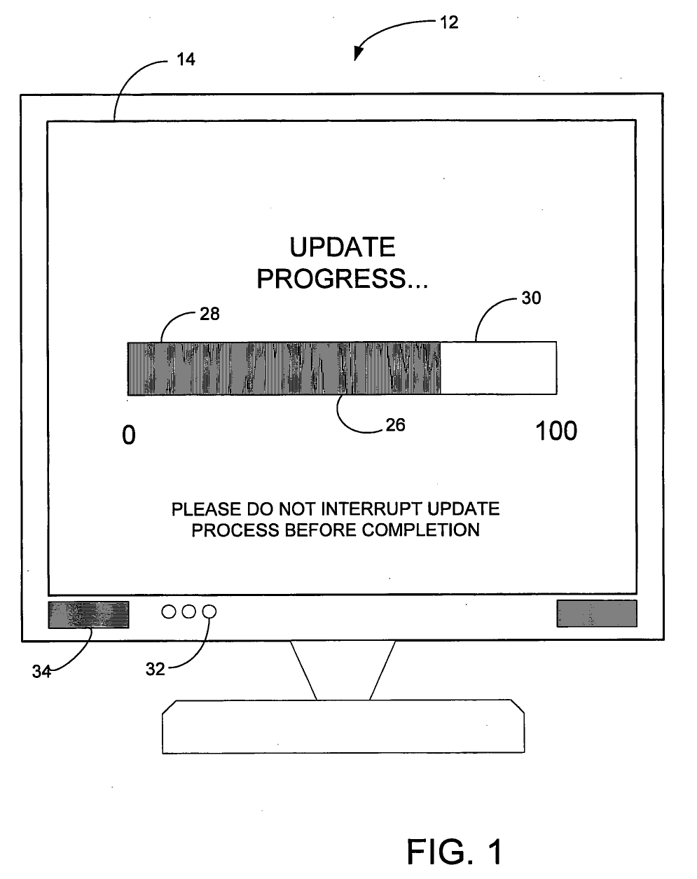

With reference now to the drawings, and in particular to FIGS. 1 through 3 thereof, the system providing a progress indicator for a monitor firmware loading process of the present disclosure is generally designated by the reference numeral 10 in this description.

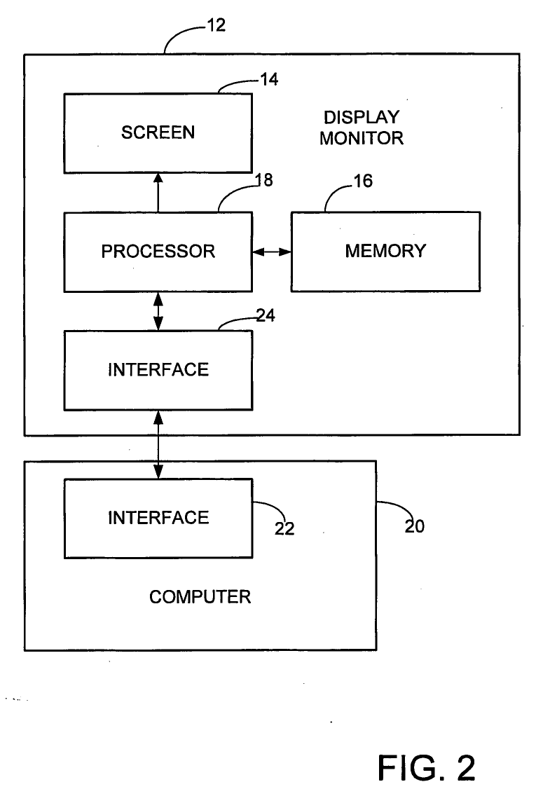

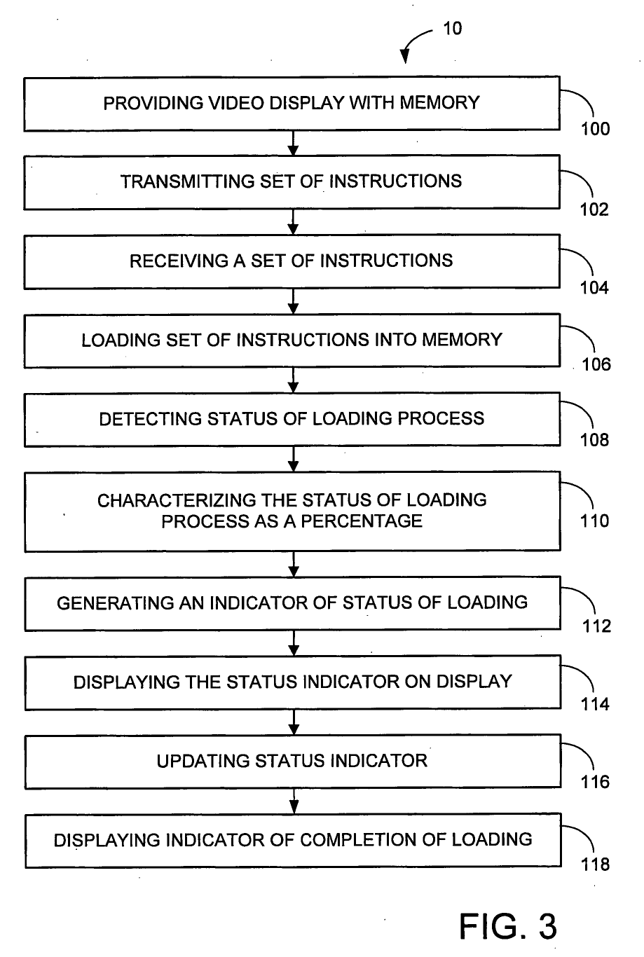

The system 10 may be implemented on a video display monitor 12 (see FIG. 1) having a display screen 14 on which images, such as moving video images, may be displayed and visually detected by the eye of a user viewing the display screen. The monitor 12 may further be provided with a memory 16 (see FIG. 2) that is configured to store a program of instructions for operating the display screen and associated components, such as is sometimes referred to as firmware (block 100 in FIG. 3). The memory 16 may be persistent memory that receives and stores information even when power is removed from the memory component. The video display monitor 12 my also include a processor 18 (see FIG. 2) for executing the instructions of the firmware, as well as utilizing information provided by a video signal supplied to the monitor 12 over a video connection. Although for the purposes of this description the system 10 is describe din terms of usage with a monitor 12, it will be recognized that the system 10 could be implemented on an apparatus that has tuning or other signal generating or processing capabilities beyond a video monitor.

The video display monitor 12 is typically utilized with a signal source, which is also typically but not necessarily a source of instructions for updating the firmware of the monitor 12. For the purposes of the present description, the signal source will be described as a computer system 20, while it should be recognized that the disclosure is not so limited and other signal sources may be utilized. The computer system 20 may include a video display adapter 22 that may be incorporated into the system 20, and the display adapter 22 may be interfaced with or connected to the display monitor 12 in any suitable manner, and the display monitor may include an interface 24 including circuitry appropriate for the type of communication protocol utilized.

The system 10 may be implemented as a process or method (see FIG. 3), and may comprise a program stored on the display monitor 12 as a set of instructions that may be invoked when the loading of a new set of instructions such as firmware, is initiated. The set of instructions for implementing the system 10 may be persistent through any updating process, or may optionally be updatable.

In one aspect of the system 10, a set of instructions for operation of the display monitor 12 (and not necessarily including instructions for operation of the method of the present disclosure) may be received by the computer system 20 that is connected to the video display monitor 12 (block 102). The set of instructions may include updates or enhancements to the firmware utilized by the monitor, or virtually any other type of code that may be utilized by the monitor and may be stored in the memory 16 of the display monitor 12. The set of instructions may be received over a network connection of the computer system 20, from media connected to the computer such as compact discs (CD), digital versatile discs (DVD), devices utilizing the Universal Serial Bus (USB) interface of the system 20, or virtually any other means for communicating instructions to the computer system so that the instructions can be communicated to the display monitor. The computer system 20 may then transmit the set of instructions to the display monitor 12, such as through the video display adapter 22 to the monitor 12. Those skilled in the art will recognize that the transmission of the instructions from the computer system 20 to the monitor 12 may be achieved using a video interface cable or by wireless transmission. Optionally, the set of instructions may be communicated to the display monitor 12 in ways other than through a connected computers system 20, such as directly through a wired or wireless network connection, or through media interfaced to the display monitor, such as by a USB device connected to a USB port on the monitor or CD or DVD media inserted into a suitable drive incorporate into the monitor.

The set of instructions communication or transmitted by the computer system 20 (or other suitable device) are received by the video display monitor 12, such as by the interface 24 of the monitor (block 104). The set of instructions may be directed to the memory 16 of the display monitor 12, and may be loaded into the memory of the monitor 12 under the direction or control of the processor 18.

The system 10, such as by the processor 18, may detect a status of the loading process of the set of instructions into the memory 16 of the display monitor 12 (block 108). This monitoring of load status may be accomplished in any suitable manner. For example, an initial portion of the transmission of the instructions may include a total size of the set of instructions to be loaded, and the processor 18 may monitor the amount of data received for the set of instructions with respect to the total size of the set of instructions. The status thus may reflect the portion of the total size of the set of instructions that has been received and loaded onto the memory 16 at any particular time when the status is being detected by the processor 18. The status of the loading may be characterized as a percentage that represents the amount of the set of instructions that have been loaded into the memory divided by the total size of the set of instructions to be loaded into memory (block 110). It should be recognized that the status may represent not only the portion of the total size or amount of the set of instructions that have been loaded into the memory, but may also reflect other tasks that may need to be accomplished as a part of the loading or updating procedure prior to the display monitor 12 being in a condition to resume normal display operation.

The system 10 may generate an indication of the status of the loading of the set of instructions into the memory (block 112) of the display monitor. For example, the processor 18 may generate instructions for the display screen circuitry. In one embodiment, the instructions cause the display screen 14 and associated circuitry to display the indication of the status of the loading of the set of instructions (block 114). In various embodiments, the indication may comprise display of a progress bar 26 on the screen 14. Illustratively, the progress bar 26 may include a plurality of segments, and each of the segments may be of a first character or a second character. The segments 26 of the first character may represent the portion of the total size of the set of instructions that have been loaded onto the memory 16, and segments 30 of the second character may represent a portion of the total size of the set of instructions that have not been loaded onto the memory. The segments 28 of the first character may and preferably are visually differentiated from the segments 30 of the second character. For example, this visual differentiation may be accomplished through the use of different colors for the segments 28 of the first character and the segments 30 of the second character. It should be recognized that the individual segments need not be visually differentiated from each other, as long as the segments 28 are visually differentiated from the segments 30.

The indicator 26 thus provides a visual indication of the portion or percentage of the total size of the instructions that have been loaded into the memory. The indication displayed may be periodically refreshed as the percentage is periodically recalculated by the processor. As a result, the number of segments 28 of the first character may increase and the number of segments 30 of the second character may decrease as the loading progresses. Optionally, additional information may be displayed with the progress bar 26 such as a warning not to interrupt the loading process prior to completion, an indication of the load start and load end locations on the progress bar 26, and a general label or explanation of the progress bar being displayed.

In addition to the display of an indication on the display screen 14, or as an alternative to the display of the indication, the processor may provide other visual or audible indications that the updating process is still in progress and has not been completed. For example, in some embodiments, the processor 18 may cause one or more lights 32, such as light emitting diodes (LEDs), to illuminate, or alternatively illuminate and extinguish, until the process of updating is completed. In some embodiments, the processor 18 may cause speakers 34 could provide an audible noise that continues as long as the updating process continues, or periodically provides an audible indication that the updating process is proceeding. The audible indication could indicate what portion or percentage of the process has been completed, and may warn against the interruption of the updating process.

The method of the system 10 may also include the display of an indication of the completion of the loading of the set of instructions into the memory (block 118) and the updating process.

While the invention is disclosed as a method, i.e., in terms of flowcharts, it will be understood by a person of ordinary skill in the art that a processor apparatus, such as a conventional data processor, including a CPU, memory, I/O, program storage, a connecting bus, and other appropriate components, could be programmed or otherwise designed to facilitate the practice of the method of the invention. Such a processor would include appropriate program means for executing the method of the invention.

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely Within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

Therefore, the foregoing is considered as illustrative only of the principles of the invention. Further, since numerous modifications and changes will readily occur to those skilled in the art in view of the disclosure of this application, it is not desired to limit the invention to the exact embodiments, implementations, and operations shown and described. Accordingly, all equivalent relationships to those illustrated in the drawings and described in the specification, including all suitable modifications, are intended to be encompassed by the present invention that fall within the scope of the invention.

I claim:

1. A method of providing an indication to a user of a status of an updating process of a video display monitor, comprising:
receiving a set of instructions by the video display monitor;
loading the set of instructions into a memory of the video display monitor;
detecting a status of the loading of the set of instructions into the memory of the video display monitor;
generating an indication of the status of the loading of the set of instructions into the memory of the video display monitor; and
displaying the indication of the status of the loading of the set of instructions by the video display monitor.

2. The method of claim 1 wherein the indication comprises a visual indication of the status on the display screen.

3. The method of claim 2 wherein displaying comprises displaying a progress bar on a video screen of the video display monitor.

4. The method of claim 3 wherein the progress bar includes a plurality of segments, each of the segments being of a first character or a second character, segments of the first character representing a portion of the total size of the set instructions having been loaded onto the memory and segments of the second character representing a portion of the total size of the set of instructions having not been loaded onto the memory.

5. The method of claim 1 additionally comprising characterizing the status of the loading as a percentage.

6. The method of claim 1 wherein the detecting of the status, the generating of the indication, and the displaying of the indication is performed periodically during the updating process.

7. The method of claim 1 wherein the displaying of the indication of the status comprises providing an audible indication of the status.

8. The method of claim 1 additionally comprising displaying an indication of completion of the loading of the set of instructions into the memory.

10. The method of claim 1 wherein the status reflects a portion of a total size of the set of instructions that is loaded onto the memory at a time when the status is detected.

11. The method of claim 1 additionally comprising providing a video display monitor including a memory configured to store firmware instructions, the video display monitor including a display screen, the video display monitor including a processor for executing the firmware instructions; and
receiving a set of instructions by a computer system connected to the video display monitor, the computer system including a video display adapter interfaced with the display monitor, the computer system transmitting the set of instructions through the video display adapter to the monitor.

12. A system for providing an indication to a user of a status of an updating process of a video display monitor, comprising:
a video display monitor including a display screen, a memory configured to store firmware instructions, a processor for executing the firmware instructions; and
a first set of instructions stored on the memory and configured to cause the processor to:
receive a second set of instructions;
load the second set of instructions into the memory,
detect a status of the loading of the second set of instructions into the memory;
generate an indication of the status of the loading of the second set of instructions into the memory; and
display the indication of the status of the loading of the second set of instructions.

13. The system of claim 12 wherein the indication comprises a visual indication of the status on the display screen.

14. The system of claim 13 wherein displaying comprises displaying a progress bar on a video screen of the video display monitor.

15. The system of claim 14 wherein the progress bar includes a plurality of segments, each of the segments being of a first character or a second character, segments of the first character representing a portion of the total size of the set instructions having been loaded onto the memory and segments of the second character representing a portion of the total size of the set of instructions having not been loaded onto the memory.

16. The system of claim 12 wherein the first set of instructions is additionally configured to cause the processor to character the status of the loading of the second set of instructions as a percentage.

17. The system of claim 12 wherein the detecting of the status, the generating of the indication, and the displaying of the indication is performed periodically during the updating process.

18. The system of claim 12 wherein the displaying of the indication of the status comprises providing an audible indication of the status.

19. The system of claim 12 wherein the first set of instructions is additionally configured to cause the processor to display an indication of completion of the loading of the set of instructions into the memory.

20. The system of claim 12 wherein the status reflects a portion of a total size of the set of instructions that is loaded onto the memory at a time when the status is detected.
